(19) United States
(12) Patent Application Publication
(10) Pub. No.: US 2018/0121011 A1
(43) Pub. Date: May 3, 2018

(54) ELECTROCHROMIC TOUCHSCREEN DEVICE

(71) Applicant: iGlass Technology, Inc., Irvine, CA (US)

(72) Inventors: Evgeny Vasilyev, Novosibirsk (RU); Nikita Kruglikov, Novosibirsk (RU)

(21) Appl. No.: 15/338,453

(22) Filed: Oct. 31, 2016

(51) Int. Cl. G06F 3/041

(52) U.S. Cl. CPC G06F 3/0416; G06F 2203/04102

(57) ABSTRACT

The invention pertains generally to an area encompassing transparent electrochromic devices and touchscreens. The invention relates to a device featuring both functions of flexible electrochromic films and touchscreens. The invention may be used as a basis for the operation of smart glass and information image displays. It can be employed in the fields of construction and automotive glazings, as it possesses the ability to change its optical state in response to the application of an electric field stimulus, and as such may be used in capacitive touchscreens.

The EC touchscreen device contains an electronic structure of touch detection that consists of the following layers as a minimum: transparent substrate coated with transparent flexible conductive layer that has a polymer-based EC material with shape memory disposed on its surface and a transparent flexible conductive layer that covers another substrate. The device is supplied with both a power unit and a control unit, designed to transmit discrete scanning signals independent of any other signal.

### TECHNICAL FIELD

The invention pertains generally to an area encompassing transparent electrochromic devices and touchscreens. The invention relates to a device featuring both functions of flexible electrochromic films and touchscreens. The invention may be used as a basis for the operation of smart glass and information image displays. It can be employed in the fields of construction and automotive glazings, as it possesses the ability to change its optical state in response to the application of an electric field stimulus, and as such may be used in capacitive touchscreens.

### BACKGROUND OF THE INVENTION

Electrochromism (EC) is a physical phenomenon that has been known about since the 19^{th} century and first patents describing its practical implementation were registered in the mid-1950s, e.g., U.S. Pat. No. 2,632,045 (dated Mar. 17, 1953), while potential smart glass devices started being patented only in the late 1970s, e.g., U.S. Pat. No. 3,819,252 (dated Jun. 25, 1974) or U.S. Pat. No. 4,194,812 (dated Mar. 25, 1980).

Smart glass devices generally comprise several layers held between two transparent electrodes with electric potential applied to them. A series of densely packed layers is usually arranged between the two electrodes: an active electrochromic layer, a layer of fast ion conductor and an ion storage layer. The substrate of a transparent conducting electrode may consist of glass plates that are covered with a transparent thin layer of conducting ITO (indium-tin oxide) film, fluorine-doped tin oxide as described in U.S. Pat. No. 6,587,250 B2.

As described in U.S. Pat. No. 4,194,812, the active electrochromic layer (main electrode) and the ion storage layer (counter electrode) are generally formed by vapor-depositing WO3 and V2O5 respectively in a thin film-conductive metal oxide.

The ionic conductor layer can be realized in various ways; as is described in the U.S. Application 2009/0078917 A1, it can be made of polymer electrolytes such as polyethylene oxide, containing lithium salts (e.g. lithium triflate).

Recently, a number of EC devices have appeared that contain a lower number of layers. Such a design generally comprises one EC layer that reversibly changes its state to either clear or dark as a result of reversible redox reaction caused by applied electric potential. In particular, the viologens combined with either ferrocene or phenazine derivatives are materials most frequently employed in such EC devices, e.g. U.S. Pat. No. 6,045,724.

Of particular interest are EC devices that employ flexible polymer films, e.g., PET, PEN, PVC and the like as substrates for transparent electrodes. Such substrates are generally covered with a solid conductive layer of either ITO or fluorine-doped tin oxide or have micron metal mesh fabricated by means of printing (Mianyang Prochema Commercial Co., Ltd.), self-assembling nanoparticle technology (Cima NanoTech, Cambrios Technologies Corporation) or lithography (Rolith, Inc.). Certain specific examples of such EC devices are described in the U.S. Application No. 2015/0355519.

Touchscreens have been present since the 1970s, with U.S. Pat. No. 3,662,105 and U.S. Pat. No. 3,798,370.

Modern touchscreens generally consist of two parts; the first part serves to detect a touch of the screen (e.g., fingers, credit cards, stylus, etc.) and determine the exact coordinates of touch area, while the other provides visualization of information including touch response, an area where various types of modern screens have been quite successful.

Both touch detection and coordinates were successfully employed in various touchscreen technologies: resistive touchscreens, capacitive touchscreens, SAW-based touchscreens, IR touchscreens, DST touchscreens (Dispersive Signal Technology by 3M TouchSystems), APR touchscreens (Acoustic Pulse Recognition by Elo Touch Solutions), inductive touchscreens, etc.

Some of the aforementioned technologies (e.g., capacitive touchscreens) may be employed in EC device technology, especially those consisting of as few layers as possible and based on transparent flexible electrodes.

U.S. Application 2012242614 A1 describes an EC structure made of the following layers: electrode, EC layer, electrolyte and another electrode. The presence of the electrolyte is a matter of principle as it indicates that an inorganic EC material is described, which is generally based on oxide ceramic of such elements as WO3, V2O5, etc. The aforementioned materials exhibit fragility, thus protecting it with a hard substrate (glass, hard plastic) is necessary. In addition, U.S. Application 2012242614 A1 provides a description and figures to controlling and scanning signals with which interference between lower frequency signals (EC component control) and higher frequency signals (touch detection) are employed.

Some objectives of this invention and technical results obtained by using it are to both improve device reliability and extend its scope of application.

Another object of this invention is to improve detecting and controlling accuracy.

In particular, improving device reliability is achieved by employing polymer EC materials that feature flexibility which are absent in the prototype material.

This also enables the usage of flexible substrate (e.g., PET, barrier films, flexible glass, etc.) which extends the scope of application.

This device features discrete time signals of various types sent to an EC device separately—it either controls an EC component of the device or detects touches on the screen. Both stand-alone functioning of device components and ability to independently transmit additional service signals have proved this system to be advantageous.

Another advantage is that being alternative to the prototype, such functionality (discrete time signals transmission) allows increased detection and control accuracy.

### SUMMARY OF THE INVENTION

The following definitions are used in this summary.

Polymer-based EC material with shape memory:

‘polymer-based’ is defined here as either a polymer solution (a mixture of components dissolved in a certain polymer matrix), functionalized polymer (i.e., synthesized with set properties), or both.

‘shape memory’ is defined here as certain feature of EC layer that allows it to sustain fixed thickness across the surface throughout the device's life cycle, i.e. in case the touchscreen component gets distorted by, for example, the touch of a finger, a temporary decrease in EC layer thickness is possible within the touch area, while releasing it would restore the EC layer to its original state, including its thickness, with no damage to electronic components.

‘Transparent Substrate’ or ‘Transparent Conductive Layer’

‘transparent’ is defined here as layer that exhibits light transmission above the level of 50% throughout the visible light spectrum, i.e. from 400 to 800 nm.

‘Flexible Substrate’ or ‘Flexible Layer’

‘flexible’ is defined here as layer capable of bending up to curvature radius of 4-5 cm with no damage and while sustaining functionality. A substrate should not exhibit any fractures or cracks while a electrode should also maintain conductivity.

This invention is directed to an EC touchscreen device, i.e. a device that exhibits functionality of touch detection and determining its coordinates. An EC touchscreen device contains an electronic structure of touch detection that consists of the following layers as a minimum: transparent substrate coated with a transparent flexible conductive layer that has a polymer-based EC material with shape memory disposed on its surface and a transparent flexible conductive layer covering another substrate. The device is supplied with both a power unit and a control unit designed to transmit discrete scanning signals independent of any other signal.

In one aspect of the invention, the device functions part of the time as an EC device and part of the time as a touchscreen.

In another aspect, the electrical conductive material of the touchscreen is deposited on a single continuous area.

In one aspect of the invention, the device features time discretion of both types of signals, controlling an EC component and a touchscreen. Generally, the device is employing clock signals when the EC component is addressed during the first step and touchscreen during the second.

The frequency of signals that control touchscreen mode is mostly determined by capacitive properties of both fingers and transparent flexible electrodes.

The amplitude of signals that control touchscreen mode are selected so as to remove any possible effect on the EC component, i.e. lower than the working potential range of the EC structure.

In still another aspect, the electrically conductive material of the touchscreen is deposited on several areas, without direct continuity in between.

In another aspect, the electronic structure is arranged in a matrix, in which matrix elements are electrically insulated from each other.

In yet another aspect, the touch detection operates by measuring signal frequency.

In another aspect of the invention, the touch detection operates by measuring signal amplitude.

In another aspect, the touch detection operates by measuring the electric charge time.

In another aspect, a flexible substrate (e.g., film or glass) is preferably used as primary and/or secondary substrate.

### BRIEF DESCRIPTION OF THE DRAWINGS

FIG. 1 depicts the layered EC structure of the device.

FIG. 2 is a schematic view of electric signals that control both EC and touchscreen components.

### DETAILED DESCRIPTION OF THE INVENTION

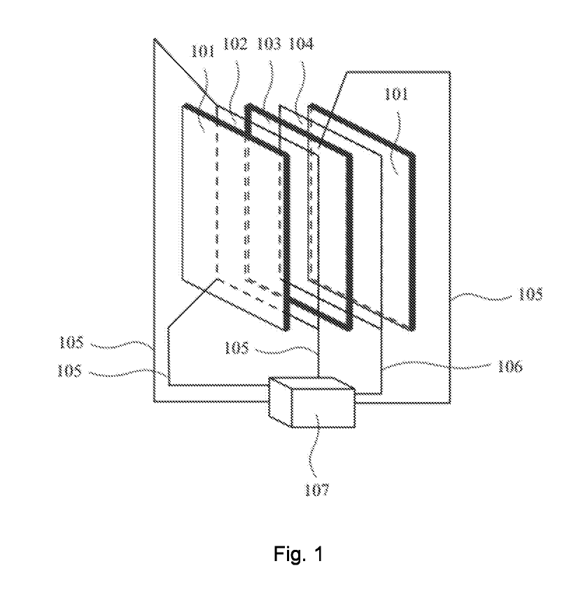

FIG. 1 depicts one of the possible implementations of the layered EC structure of the device. Two flexible film substrates (101) contain a flexible transparent electrode (102) in between them, a sensor electrode (102), an organic EC layer (103) and another flexible transparent electrode (104). The sensor electrode (102) is supplied with wires (105) that deliver applied potential to it during the EC phase. It is also supplied with another wire (106) so as to apply potential to the second electrode (104) during the EC phase. The aforementioned wires (105, 106) are connected with the power/control unit (107).

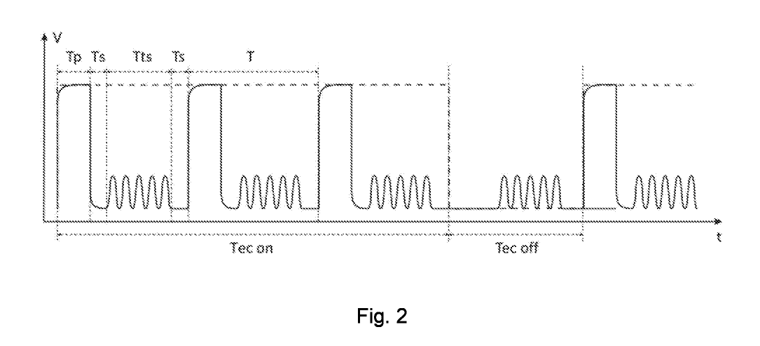

FIG. 2 is a schematic view of power amplitudes of electric signals that control both EC and touchscreen components according to the scope of the present invention.

FIG. 2 depicts the following intervals:
Tec on—an interval during which device is turned off (dark state);
Tec off—an interval during which device is turned on (clear state);
Tp—an interval when a power impulse is applied to the device;
Tts—an interval when a touch scanning impulse is applied to the device;
Ts—a stand-by interval for any transition processes to complete;
T—a single clock interval when EC component's power supply and touch detection are consequently carried out;

An electrochromic device, defined by changing its optical state in response to the application of electric potential, shows electric characteristics similar to those of a capacitor, which has characteristics common to technologies used in making touchscreens, specifically those based on measuring electric capacity variations.

FIG. 2 depicts several power amplitudes controlling the device that embodies the present invention. The dotted line shows an amplitude envelope that refers to phases of EC component of the device, i.e. darkening/clearing. The device's operation series is a cycle of clock signals that consequently power the EC component and carry out touch detection.

The clock signal duration is relatively short. Clock frequency must be sufficient so as to both remove any scintillation in functioning of an EC component and provide accurate touch detection.

The discrete nature of EC and touchscreen component signals allows a wide range of variations provided that other conditions are met according to the present invention.

The electrochromic device operates as a capacitor. Sensors connected to the electric material layers (electrodes) detect changes in electric capacity, e.g. through contact of a finger with the surface of the device. Control electronics trigger an electric action in response to the touch detection.

The methods for detecting changes in capacity include and are not limited to:
frequency measurement (FM);
amplitude measurement (AM);
charge/discharge time.

Thus, a single device operates as a display through the variations in color of the electrochromic material layer, and as a touch sensor, through touch detection via the same electrodes which operate the electrochromic material.

In another preferred embodiment of the present invention, the electrically conductive material is deposited in several areas, without direct continuity in between.

In another preferred embodiment of the present invention, a surface may be covered by electrochromic cells of minute dimensions and arrayed in a regular fashion on a surface, being controlled in a matrix and precise way, configuring an electrochromic visualization device having image update capability.

Variation in voltage will be periodically applied to the electrochromic cell matrix, keeping it continuously charged. At least one sensor will be permanently connected to the electrochromic cell matrix. When surface contact with the matrix occurs, e.g. with a finger, with more than one sensor it is possible to have information that allows the device to locate the touch on the matrix. This allows for a visualization device which can be continuously updated, and which, by means of control logic including computer programs, can dynamically use partial regions of the matrix to trigger the appearance of content including, but not limited to, the very configuration of the electrochromic cell matrix.

1. An electrochromic (EC) touchscreen device comprising:
an electronic touch detector including:
a first transparent substrate covered by a first transparent flexible conductive layer,
the first transparent flexible conductive layer in electrical communication with a polymer-based electrochromic material,
the polymer-based electrochromic material in electrical communication with a second transparent flexible conductive layer, and
the second transparent flexible conductive layer covered by a second substrate; and
a controller configured to:
provide a first control signal to the first and second conductive layers to supply power to the electrochromic material; and
provide a second control signal to the first and second conductive layers to detect a user touch,
wherein the first control signal is active and the second control signal is not active over a first duration of time, and wherein the second control signal is active and the first control signal is not active during a second duration of time that does not overlap with the first duration of time.

2. The EC touchscreen device according to claim 1, wherein the electrochromic material is deposited on a single continuous area.

3. The EC touchscreen device according to claim 1, wherein the electrochromic material is deposited on a plurality of areas, without direct continuity in between.

4. The EC touchscreen device according to claim 1, wherein the first and second conductive layers of the electronic touch detector are arranged in a matrix including a plurality of elements electrically insulated from each other.

5. The EC touchscreen device according to claim 1, wherein the touch detection operates by measuring signal frequency.

6. The EC touchscreen device according to claim 1, wherein the touch detection operates by measuring signal amplitude.

7. The EC touchscreen device according to claim 1, wherein the touch detection operates by measuring electric charge time.

8. The EC touchscreen device according to claim 1, wherein the second substrate is transparent.

9. The EC touchscreen device according to claim 1, wherein at least one of the first or second substrates is flexible.

10. The EC touchscreen device according to claim 1, wherein at least one of the first or second substrates comprises film or glass.

11. The EC touchscreen device according to claim 1, wherein the controller is further configured to provide the first control signal periodically with each period lasting the first duration of time and provide the second control signal periodically with each period lasting the second duration of time, and wherein the periods of the first and second control signals do not overlap in time.

12. The EC touchscreen device according to claim 1, wherein the controller is configured to alternate the first and second control signals.

13. The EC touchscreen device according to claim 1, wherein the controller is configured to alternate the first and second control signals based on a clock signal.

14. The EC touchscreen device according to claim 1, wherein the polymer-based electrochromic material comprises material with shape memory.

15. An electrochromic (EC) touchscreen device comprising:
first and second transparent substrates positioned opposite each other;
first and second transparent flexible electrodes positioned opposite each other and between the first and second substrates, the first electrode positioned to be at least partially covered by the first substrate, and the second electrode positioned to be at least partially covered by the second substrate;
a polymer-based electrochromic layer positioned between the first and second electrodes, the electrochromic layer in electrical communication with the first and second electrodes; and
a controller configured to:
provide a first control signal to the first and second electrodes to supply power to the electrochromic layer; and
provide a second control signal to the first and second electrodes to detect a user touch,
wherein the first control signal is active and the second control signal is not active over a first duration of time, and wherein the second control signal is active and the first control signal is not active during a second duration of time that does not overlap with the first duration of time.

16. The EC touchscreen device according to claim 15, wherein at least one of the first or second substrates is flexible.

17. The EC touchscreen device according to claim 15, wherein the controller is further configured to provide the first control signal periodically with each period lasting the first duration of time and provide the second control signal periodically with each period lasting the second duration of time, and wherein the periods of the first and second control signals do not overlap in time.

18. The EC touchscreen device according to claim 17, wherein the controller is configured to alternate the first and second control signals.

19. The EC touchscreen device according to claim 18, wherein the controller is configured to alternate the first and second control signals based on a clock signal.

20. The EC touchscreen device according to claim 15, wherein the controller is configured to detect the user touch based on a change in capacitance sensed by at least one of the first or second electrodes.
